(19) United States
(12) Patent Application Publication
(10) Pub. No.: US 2026/0261367 A1
(43) Pub. Date: Sep. 3, 2026

(54) CONTINUOUS RATE-MATCHING FOR HARQ RE-TRANSMISSION

(71) Applicant: Qualcomm Incorporated, San Diego, CA (US)

(72) Inventors: Morteza SOLTANI, San Diego, CA (US); Mostafa Khoshnevisan, San Diego, CA (US); Jing Sun, San Diego, CA (US)

(21) Appl. No.: 19/066,614

(22) Filed: Feb. 28, 2025

(51) Int. Cl. H04L 1/1822; H04L 1/00

(52) U.S. Cl. CPC H04L 1/1822; H04L 1/0013

(57) ABSTRACT

This disclosure provides systems, methods and apparatuses for transmitting data using continuous rate-matching. A transmitting device encodes data for a hybrid automatic repeat request (HARQ) process as a plurality of encoded bits and selects a subset of the plurality of encoded bits for a transmission based on a constant number of bits for the HARQ process and a redundancy version of the transmission. The transmitting device transmits control information including a redundancy version identifier (RVID) field that indicates the selected redundancy version the subset of the plurality of encoded bits according to the control information. A receiving device receives the control information including the RVID field. The receiving device loads coded bits of the transmission starting at a starting position within a circular buffer based on the RVID field and the constant number of bits. The receiving device decodes the coded bits within the circular buffer.

### TECHNICAL FIELD

The present disclosure relates to wireless communications including continuous rate-matching for hybrid automatic repeat request (HARQ) re-transmission.

### DESCRIPTION OF THE RELATED TECHNOLOGY

Wireless communication systems are widely deployed to provide various telecommunication services such as telephony, video, data, messaging, and broadcasts.

Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

In some aspects, the techniques described herein relate to an apparatus for wireless communication, including: one or more memories, individually or in combination, having instructions; and one or more processors, individually or in combination, configured to execute the instructions and cause the apparatus to: receive control information including a redundancy version identifier (RVID) field associated with a hybrid automatic repeat request (HARQ) process; load coded bits of a transmission scheduled by the control information starting at a starting position within a circular buffer based on the RVID and a constant number of bits for the HARQ process; and decode the coded bits within the circular buffer.

In some aspects, the techniques described herein relate to an apparatus for wireless communication, including: one or more memories, individually or in combination, having instructions; and one or more processors, individually or in combination, configured to execute the instructions and cause the apparatus to: encode data for a hybrid automatic repeat request (HARQ) process as a plurality of encoded bits; select a subset of the plurality of encoded bits for a transmission based on a constant number of bits for the HARQ process and a redundancy version of the transmission; transmit control information including a redundancy version identifier (RVID) field that indicates the selected redundancy version; and transmit the subset of the plurality of encoded bits according to the control information.

In some aspects, the techniques described herein relate to a method of wireless communication, including: receiving control information including a redundancy version identifier (RVID) field associated with a hybrid automatic repeat request (HARQ) process; loading coded bits of a transmission scheduled by the control information starting at a starting position within a circular buffer based on the RVID and a constant number of bits for the HARQ process; and decoding the coded bits within the circular buffer.

In some aspects, the techniques described herein relate to a method of wireless communication, including: encoding data for a hybrid automatic repeat request (HARQ) process as a plurality of encoded bits; selecting a subset of the plurality of encoded bits for a transmission based on a constant number of bits for the HARQ process and a redundancy version of the transmission; transmitting control information including a redundancy version identifier (RVID) field that indicates the selected redundancy version; and transmitting the subset of the plurality of encoded bits according to the control information.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system including an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 is a diagram illustrating an example disaggregated base station architecture.

FIG. 5 is a diagram of a circular buffer with redundancy versions according to 5G NR.

FIG. 6 is a diagram illustrating a circular buffer with redundancy versions for continuous rate-matching.

FIG. 7 is a diagram of an example circular buffer with starting locations defined by a counter.

FIG. 8 is a diagram of an example circular buffer having starting positions defined by a one-bit counter.

FIG. 9 is a diagram of an example of reception of a transmission using multiple retransmissions with continuous rate-matching.

FIG. 10 is a message diagram illustrating example messages for configuration and use of continuous rate-matching.

FIG. 11 is a conceptual data flow diagram illustrating the data flow between different means/components in an example network entity including a continuous rate-matching Tx component.

FIG. 12 is a conceptual data flow diagram illustrating the data flow between different means/components in an example UE including a continuous rate-matching Rx component.

FIG. 13 is a flowchart of an example method for a wireless node such as a UE to receive a transmission associated with a HARQ process based on continuous rate-matching.

FIG. 14 is a flowchart of an example method for a wireless node such as a network entity to transmit a transmission associated with a HARQ process using continuous rate-matching.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, 6G or further implementations thereof, technology.

In wireless communications, hybrid automatic repeat request (HARQ) is used to automatically send retransmissions when a receiving device does not successfully decode a transmission. Data for transmission is encoded into systematic bits and parity bits. For example, 5G NR HARQ performs retransmissions based on incremental redundancy which are controlled by a HARQ Redundancy Version (RV) ID. At each instance of data transmissions (either initial transmissions or re-transmissions), a HARQ RVID is indicated to determine which set of bits are selected for transmission. Different RV IDs correspond to different starting bits of a set of bits being transmitted. For instance, 5G NR may use a circular buffer and a specific interleaving pattern for each RV to select the bits for transmission. Each RV will provide a different portion of the rate-matched output, increasing the chances of successful decoding at the receiver. Each RV is constructed from the bits in a circular buffer that are stored during the rate match process. In 5G NR, up to 4 RVIDs are supported. In 5G NR, the 4 RVIDs are defined in such a way that the rate-matched coded bits may overlap for some RVIDs. This may result in a lower coding gain compared to a system where the transmitted bits do not overlap.

The present disclosure provides a system of continuous rate-matching where the transmitted bits for transmissions and re-transmissions associated with a HARQ process do not overlap. That is, each RV corresponds to a unique set of bits within the circular buffer. Continuous rate matching may increase coding gain by increasing the number of RVIDs. The increase in number of RVIDs may imply an increase in a size of an RVID field in downlink control information (DCI), which could increase signaling overhead or affect backward compatibility. In an aspect, continuous rate-matching may use transmissions and retransmission based on a constant number of bits for a HARQ process. The RVID field may remain a same size (e.g. 2 bits) and be interpreted as either a counter or absolute value of the retransmission. Accordingly, a receiving device may determine a location within a circular buffer of the coded bits of a transmission. Even when a DCI for an initial transmission is missed, the receiving device can determine the location for the coded bits of the retransmission based on the RVID and the constant number of bits.

In an aspect, the techniques disclosed herein can increase coding gain of transmissions using continuous rate matching without changing a size of a DCI. The DCI format may be backward compatible with 5G NR RVID signaling. The techniques disclosed herein may allow a receiving device to decode retransmissions even if scheduling of an initial transmission is not received.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

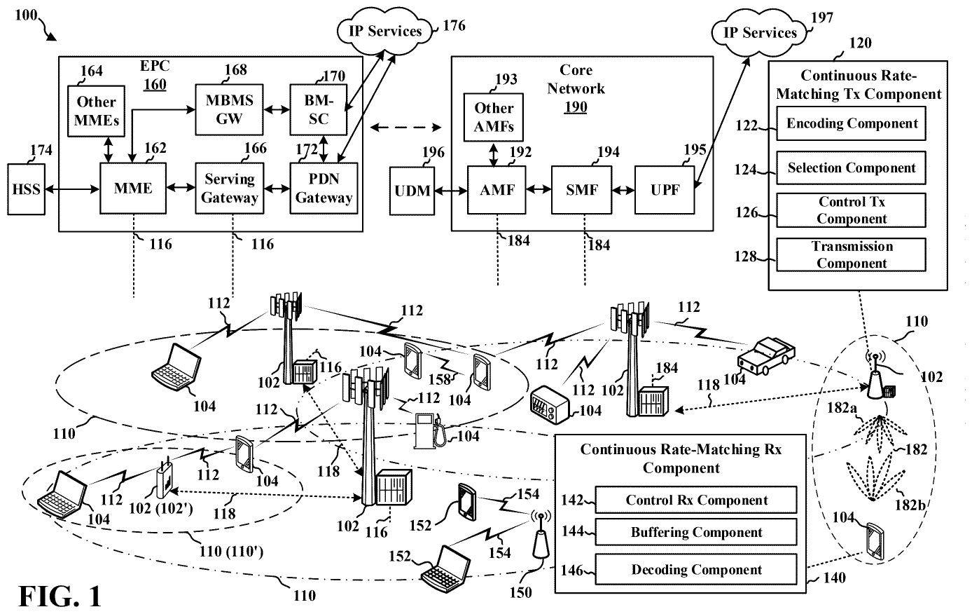

FIG. 1 is a diagram illustrating an example of a wireless communications system and an access network 100. The wireless communications system (also referred to as a wireless wide area network (WWAN)) includes wireless nodes such as base stations 102 and UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as one or more central units (CUs), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs.

In some implementations, one or more wireless nodes such as the UEs 104 include a continuous rate-matching receive (Rx) component 140 configured to receive one or more transmissions for a HARQ process having a constant number of bits. The continuous rate-matching Rx component 140 includes control Rx component 142, a buffering component 144, and a decoding component 146. The control Rx component 142 is configured to receive control information (e.g., downlink control information (DCI)) including a redundancy version identifier (RVID) field associated with a HARQ process. The buffering component 144 is configured to load coded bits of a transmission scheduled by the control information starting at a starting position within a circular buffer based on the RVID and a constant number of bits for the HARQ process. The decoding component 146 is configured to decode the coded bits within the circular buffer.

In some implementations, one or more of the wireless nodes such as the network entities including a base station 102 may include a continuous rate-matching Tx component 120. In particular, the continuous rate-matching Tx component 120 is configured to transmit one or more transmissions for a HARQ process having a constant number of bits. The continuous rate-matching Tx component 120 includes an encoding component 122, a selection component 124, a control Tx component 126, and a transmission component 128. The encoding component 122 is configured to encode data for a hybrid automatic repeat request (HARQ) process as a plurality of encoded bits. The selection component 124 is configured to select a subset of the plurality of encoded bits for a transmission based on a constant number of bits for the HARQ process and a redundancy version of the transmission. The control Tx component 126 is configured to transmit control information (e.g., DCI) including a redundancy version identifier (RVID) field that indicates the redundancy version. The transmission component 128 is configured to transmit the subset of the plurality of encoded bits according to the control information.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 116 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 118 (such as X2 interface). The third backhaul links 118 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station may utilize beamforming 182 with the UE 104 to compensate for the path loss and short range. For example, the base station 102 may use beamforming 182 to transmit beams 182a and the UE 104 may utilize beamforming 182 to transmit beams 182b.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 6G, the concepts described herein may be applicable to other similar areas, such as 5G NR, LTE, LTE-A, CDMA, GSM, and other wireless technologies including future wireless technologies.

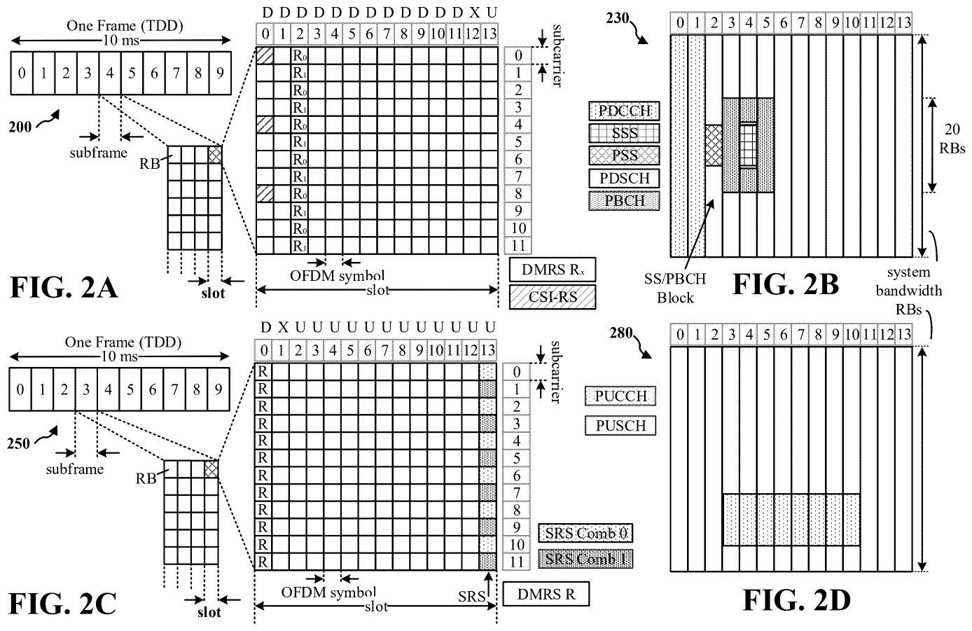

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one. In an aspect, a narrow bandwidth part (NBWP) refers to a BWP having a bandwidth less than or equal to a maximum configurable bandwidth of a BWP. The bandwidth of the NBWP is less than the carrier system bandwidth.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 slots/subframe. The subcarrier spacing and symbol length/duration are a function of the numerology. The subcarrier spacing may be equal to 2^{μ*15} kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DMRS) (indicated as Rx for one particular configuration, where 100x is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a L1 identity. A secondary synchronization signal (SSS) may be within symbol 4 of particular subframes of a frame. The SSS is used by a UE to determine a L1 cell identity group number and radio frame timing. Based on the L1 identity and the L1 cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

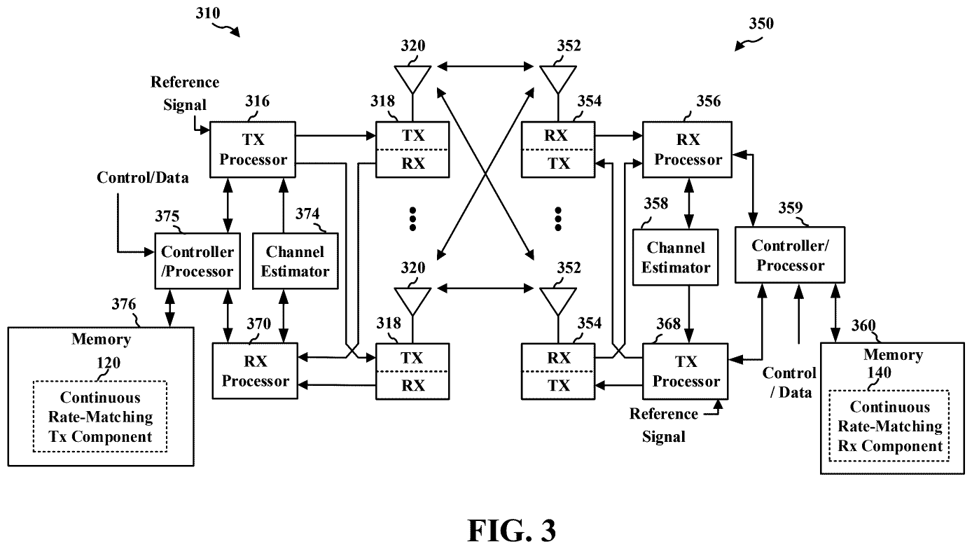

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission. In a split architecture, the transmitters/receivers 318 may be located in an RU, and the Tx processor 316, channel estimator 374, controller/processor 375, and Rx processor 370 may be located in a DU.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with the continuous rate-matching Rx component 140 of FIG. 1. For example, the memory 360 may include executable instructions defining the continuous rate-matching Rx component 140. The TX processor 368, the RX processor 356, and/or the controller/processor 359 may be configured to execute the continuous rate-matching Rx component 140.

At least one of the TX processor 316, the RX processor 370, and the controller/processor 375 may be configured to perform aspects in connection with the continuous rate-matching Tx component 120 of FIG. 1. For example, the memory 376 may include executable instructions defining the continuous rate-matching Tx component 120. The TX processor 316, the RX processor 370, and/or the controller/processor 375 may be configured to execute the rate-matching Tx component 120.

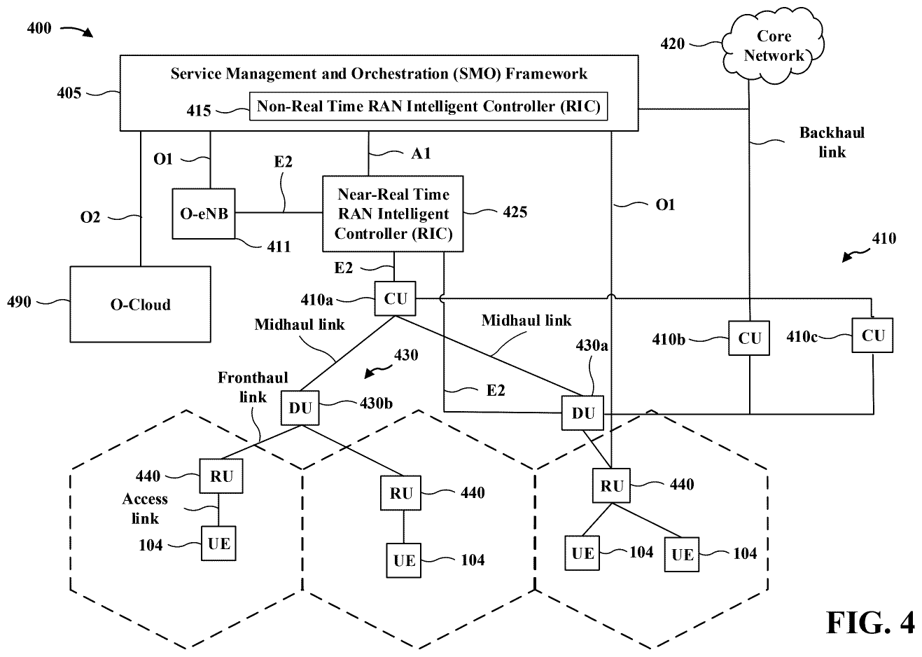

FIG. 4 is a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 (e.g., RU 430a or 430b) via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via 01) or via creation of RAN management policies (such as A1 policies).

In an aspect, a 6G split architecture may include a multi-CU shared DU. That is, multiple CUs 410 (e.g., CUs 410a, 410b, 410c) may be allowed to control a DU 430a. In order to prevent conflicts, one CU 410 (e.g., CU 410a) may be designated as a primary CU for the DU. For instance, the DU 430a may prioritize the CUs 410 such that in the event of a conflict, the higher priority CU (e.g., the primary CU 410a) controls. In some implementations, the radio resource control (RRC) layer may be located in the CU 410. A specific UE 104 may establish an RRC connection with an CU 410. The CU 410 with the RRC connection to a UE may be referred to as the anchor CU of the UE. Accordingly, as used herein with respect to a CU, the terms primary and secondary refer to the priority of the CU for a specific DU, and the term anchor refers to the endpoint of an RRC connection with a UE.

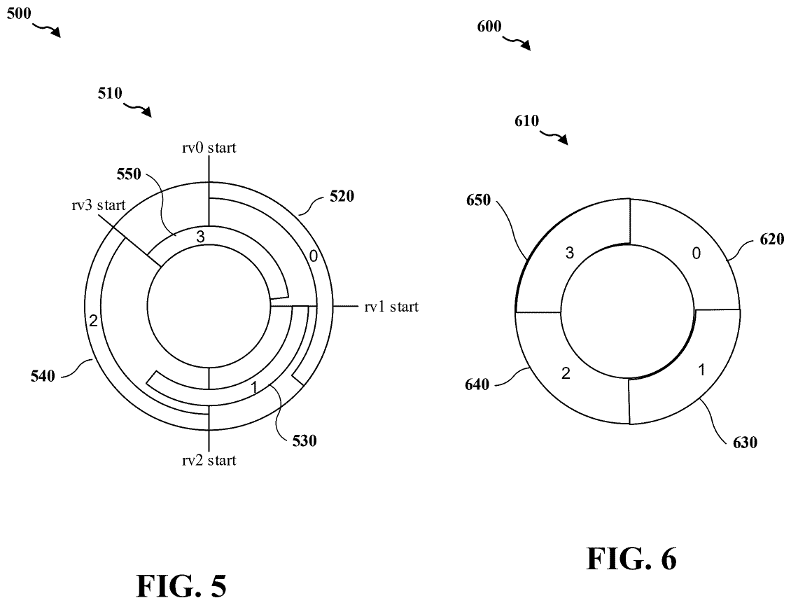

FIG. 5 is a diagram 500 of a circular buffer 510 with redundancy versions according to 5G NR. The circular buffer 510 stores received bits corresponding to encoded bits. The received bits are loaded from transmissions (e.g., on a PDSCH) based on a redundancy version. 5G NR defines four (4) redundancy versions rv0-rv3. The starting positions of the redundancy versions within the circular buffer are fixed. The bits for each RV overlap with some of the bits of the other RVs. For example, rv0 520 may include systematic bits, rv1 530 may include systematic bits and some parity bits, rv2 540 may include all parity bits, and rv3 550 may include parity bits and systematic bits. Generally, a transmitting device first transmits the bits of rv0. If the receiving device does not transmit an ACK, the transmitting device selects another RV to transmit. Although a receiving device may attempt to soft combine the overlapping bits, generally coding gain for new bits is greater than coding gain for overlapping bits. Accordingly, a transmitter may select rv2 540 for the first retransmission. For instance, a typical transmission order may be rv0, rv2, rv3, and rv1. One additional issue with the RVs according to 5G NR is that a receiving device may completely miss a first transmission of rv0. For instance, a UE may not receive the DCI indicating the scheduling of rv0. In that case, the receiving device does not have any of the systematic bits and may not be able to self-decode a later transmission.

FIG. 6 is a diagram 600 illustrating a circular buffer 610 with redundancy versions for continuous rate-matching. Once again, the circular buffer 610 stores received bits corresponding to encoded bits. However, the size (i.e., number of bits) in each redundancy version is constant and there is no overlap between redundancy versions. Each redundancy version may be transmitted sequentially. That is, the transmission order may be rv0 620, rv1 630, rv2 640, and rv3 650. The bits for each redundancy version start at the end of the previous redundancy version. Accordingly, there is no overlap of bits between redundancy versions, so the coding gain of a retransmission is greater. The use of continuous rate-matching raises an issue of how the receiving device knows where in the circular buffer to load the received bits, in particular, when the control information scheduling rv0 620 is not received. In a first aspect, the RVID field of a control information (e.g., DCI) may be interpreted as a counter. The starting position in the circular buffer 610 may be a function of the number of coded bits in the current re-transmission and the RVID field. The interpretation as a counter allows a number of redundancy versions greater than a number of code points of the RVID field. For instance, a 2-bit RVID field may be used with more than 4 redundancy versions. The starting position in the circular buffer 610 for a received transmission may be measured from a last received transmission. If no transmission is has been received, the starting position may start from the 0 position. The number of bits to skip from the end of the previous transmission is given by the following formula:

$$Skip in the Circular Buffer = ( ( {RVDI}_{current} - {RVID}_{previous} ) mod ( {2}^{x} ) - 1 ) \times B$$

where RVID_{current} is the value of the received RVID field, RVIDₚᵣₑᵥᵢₒᵤₛ is the value of the previously received RVID field, x is the number of bits in the RVID field, and B is the constant number of bits for each transmission. In other words, the starting position may be defined as an ending position of the previous transmission plus a difference between a value of the RVID field and the previous RVID reduced modulo a number of possible RVIDs minus one times the constant number of bits for the transmission. Alternatively, the starting position may be defined based on a starting position of the previous transmission as a starting position of the previous transmission plus a difference between a value of the RVID field and the previous RVID reduced modulo a number of possible RVIDs times the constant number of bits for the transmission.

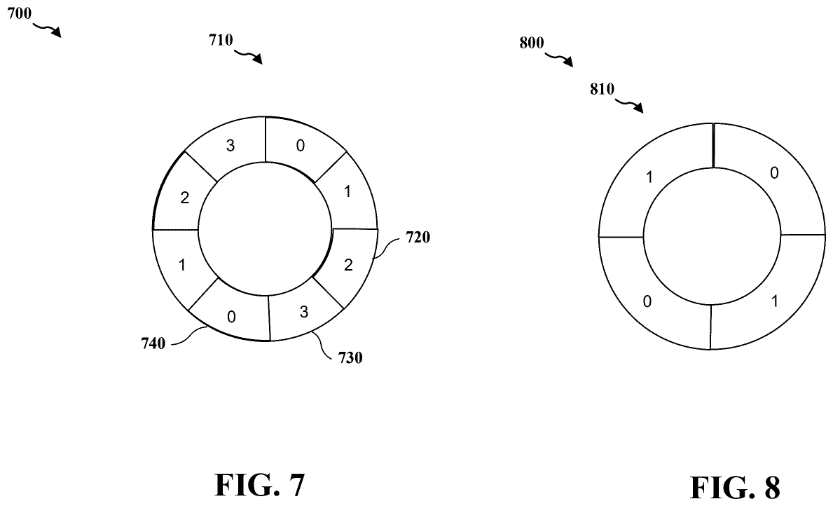

FIG. 7 is a diagram 700 of an example circular buffer 710 with starting locations defined by a counter. For example, the circular buffer 710 may allow for eight redundancy versions using a 2 bit RVID field having four codepoints that wrap around. A receiving device (e.g., a UE) may determine the starting position for bits of a transmission or retransmission based on the RVID field of the current transmission and a last received transmission. When the RVIDs are sequential, the number of bits to skip is 0, so no bits are skipped in the circular buffer 710. The modulo operation accounts for cases where the number of redundancy versions is greater than 2^{x}. As a counter, the RVID field wraps around (e.g., from 3 to 0). For example, assuming that a third transmission with RV ID=2 was previously detected, the received were bits loaded into a location 720. The receiving device then detects a transmission with RV ID=0 (wrapping around to 0 after 3, given the two bits or modulo 4 operation). Now the (RVID_{current}−RVIDₚᵣₑᵥᵢₒᵤₛ−1)=(0−2−1)=−3. This −3 is +1 with modulo 4 operation. Now the receiving device can skip B bits (e.g., corresponding to location 730) from the end of the last received transmission, and then start loading the bits from the new transmission at a location 740.

In a second aspect, the RVID field may indicate an absolute starting point in the circular buffer. The number of redundancy versions may be limited to be 2^{x} where x is the size of the RV field. The starting point in the circular buffer (in bit index) may be given by the formula:

$$Starting Point in Circular = {RVID}_{current} \times B$$

Accordingly, the starting point is dependent only on the current RVID and not any previous transmission. For example, assuming the RVID set is {0,1,2,3}, and a UE receives a DL grant of an initial transmission but misses the DL grants of all re-transmissions until it receives the DL grant of the last retransmission, the starting point for the UE to fill the circular buffer 610 for the initial transmission is 0×B=0 and the starting point for the last retransmission is 3×B.

The constant number of bits may be determined based on a transport block size of any of the transmissions. For example, the transport block size may be calculated based on the modulation and coding scheme (MCS) and resource allocation as indicated in the control information. For instance, the following formulas may be used to calculate the constant number of bits:

$$B = {N}_{R E}^{′} \times {n}_{prb} \times {Q}_{m} \times v$$

$${N}_{RE}^{′} = {N}_{s c}^{R B} \times {N}_{symb} - {N}_{DMRS}^{PRB} - {N}_{o h}^{PRB}$$

where n_{prb} is the number of resource blocks (RBs), Qₘ is the modulation order, v is the number of MIMO layers,

$${N}_{s c}^{RB}$$

is total number RBs for the data, N_{symb} is the number of OFDM symbols,

$${N}_{DMRS}^{PRB}$$

is the total number of RBs for DMRS, and

$${N}_{o h}^{PRB}$$

is the total number of RBs for overhead. The Qₘ, v,

$${N}_{sc}^{R B} ,$$

and N_{symn} may be included in the scheduling (e.g., DCI). The

$${N}_{DMRS}^{PRB}$$

and the

$${N}_{o h}^{PRB}$$

may be based on a configuration of the data channel (e.g., PDSCH).

The above formulas take into account the reserved resources for DMRS and other overhead. In some implementations, the actual output of the rate-matching may be different for each transmission or re-transmission. For instance, there may be some reserved REs or RBs for the initial transmission but there may be no reserved REs or RBs for re-transmissions. The transmitter, which is aware of the exact output of the rate matching, may enforce the same number of coded bits. If the receiving device receives scheduling (e.g., a DCI) for a retransmission with a different number of coded bits, the receiving device may determine that the scheduling is an error and discard the scheduling. Accordingly, the receiving device may calculate the constant number of bits from any scheduling.

In some implementations, the number of bits calculated by the formulas above may be rounded down when determining where to place the received bits. For instance, the transmitter may repeat bits from a previous transmissions that were larger than the constant number of bits. This near-continuous rate matching may still increase the coding gain. Accordingly, an exact continuous rate-matching may not be achieved.

In other implementations, the number of coded bits B may be calculated on the actual output of rate matching. The transmitter may allow the number of nominal coded bits across the initial transmission and retransmissions to change. The number of coded bits, however, may no longer be constant. Accordingly, a receiving device may only be able to calculate the starting position of a retransmission when the scheduling was received for each of the previous transmissions and retransmissions.

In an aspect, a UE may be configured to use either conventional redundancy versions or continuous rate matching. The configuration may be at an RRC, MAC, or PHY layer. In some implementations, at the RRC layer, the UE may indicate a capability for continuous rate matching. For example, the UE may transmit a RRC capability message with an information element indicating a capability for continuous rate matching. The network may provide an RRC message configuring continuous rate matching. For instance, the RRC message may configure a number of redundancy versions. At the MAC layer, in some implementation, the network may transmit an indication that continuous rate-matching is activated. When continuous rate-matching is activated, a UE may assume that any received DCI of a configured format uses continuous rate matching.

In some implementations, the PHY layer may dynamically indicate whether a HARQ process uses continuous rate matching. For instance, the RVID field of a DCI may indicate whether continuous rate-matching applies to the HARQ process. In some implementations, an additional bit may be added to a DCI format, either as part of the RVID field, or as a separate field. If the additional bit indicates continuous rate matching (e.g., bit=1), the RVID field (or remaining bits thereof) can be interpreted as above to determine the starting position in the circular buffer 610 for the scheduled transmission. If the additional bit indicates conventional redundancy versions (e.g., bit=0), the RVID field (or remaining bits thereof) can be interpreted with the 5G NR defined rv positions (e.g., as in FIG. 5). The additional bit, however, may increase a size of the DCI.

In some implementations, one bit of the RVID field (e.g., the most significant bit (MSB)) may indicate whether continuous rate-matching applies. The remaining bit(s) of the RVID may be interpreted as a counter. If the conventional RVID field size of 2 is used, only one bit may be interpreted as a counter.

FIG. 8 is a diagram 800 of an example circular buffer 810 having starting positions defined by a one-bit counter. The one-bit counter may allow a receiving device to correctly determine the starting location when only one DCI is missed. That is, if the counter changes, the receiving device may assume the redundancy versions are sequential and continuous. If the counter stays the same, the UE may assume that the constant number of bits should be skipped.

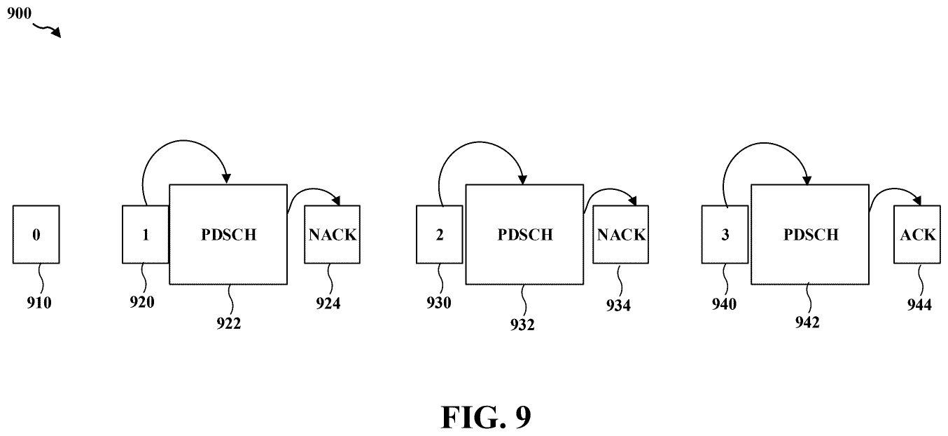

FIG. 9 is a diagram 900 of an example of reception of a transmission using multiple retransmissions with continuous rate-matching. A network entity (e.g., a gNB) may transmit a first DCI 910 having an RVID of 0 to schedule the transmission. The receiving device (e.g., a UE) may miss the DCI 910 such that the UE does not receive the transmission and does not transmit any acknowledgment. The network entity may schedule a retransmission via a DCI 920. For instance, the DCI 920 may have an RVID of 1. The UE may assume that continuous rate-matching is enabled and determine the starting location for the bits of the scheduled PDSCH 922 in the circular buffer 710 by skipping the constant number of bits. The UE may determine the constant number of bits based on the PDSCH 922 as indicated by the DCI 920. The retransmission may not be sufficient to decode the transmission, so the UE may transmit a NACK 924. The network entity may schedule a second retransmission via a DCI 930 with an RVID of 2. The UE may determine that the DCI 930 is sequential to the DCI 920 based on the RVID field and not skip any bits in the circular buffer 710. The UE may load the bits of the PDSCH 932 into the circular buffer 710. If the UE can still not decode the transmission, the UE may transmit a NACK 934. The network entity may schedule a third retransmission via a DCI 940 with an RVID of 3. The UE may determine that the DCI 940 is sequential to the DCI 930 based on the RVID field and not skip any bits in the circular buffer 710 for the PDSCH 942. The UE may then be able to successfully decode the transmission and transmit an ACK 944.

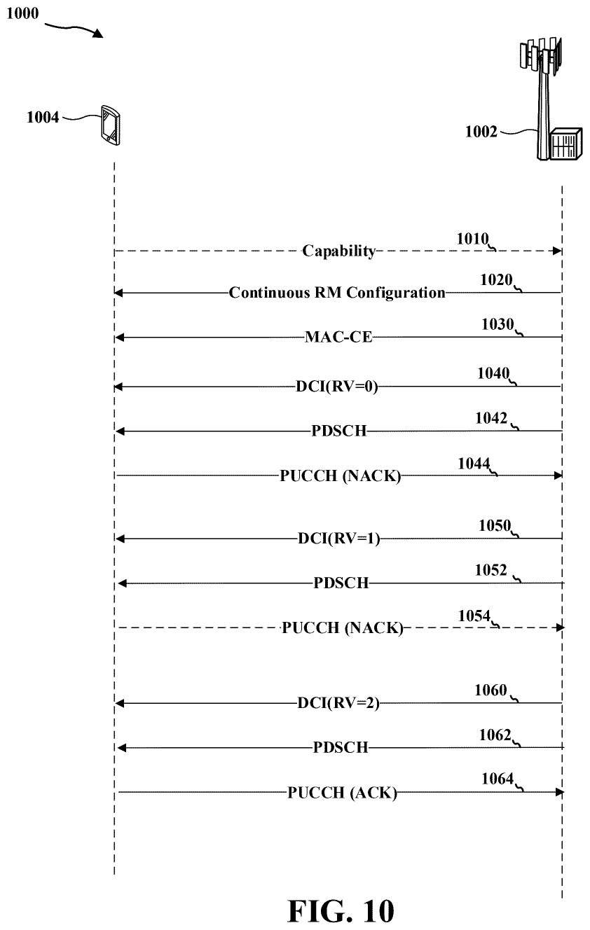

FIG. 10 is a message diagram 1000 illustrating examples messages for configuration and use of continuous rate-matching. A transmitting device 1002 may transmit data to a receiving device 1004 using continuous rate-matching.

In some implementations, the receiving device 1004 may transmit an indication of a capability 1010. For example. The indication of the capability 1010 may be an RRC message that indicates that the receiving device 1004 is capable of receiving transmissions based on continuous rate matching.

The transmitting device 1002 may transmit a continuous RM configuration 1020. For example, the continuous RM configuration 1020 may be an RRC message. The continuous RM configuration 1020 may, for example, specify a DCI format (e.g., DCI format 1_0) and a configuration of a number of redundancy versions. In some implementations, the continuous RM configuration 1020 may specify a number of bits in the RVID field and/or whether the DCI format includes an additional bit to indicate whether continuous rate-matching is applicable.

In some implementations, the transmitting device 1002 may transmit a MAC-CE 1030 to active continuous rate-matching.

When the transmitting device 1002 starts a new transmission associated with a HARQ process, the transmitting device 1002 may transmit a DCI 1040. The DCI 1040 may have a HARQ process number field that identifies the HARQ process and a new data indicator (NDI) field that is changed from a previous transmission associated with the HARQ process. The DCI 1040, being the initial transmission, has the RVID field set to 0. The DCI 1040 also includes the scheduling information for a PDSCH 1042. The transmitting device then transmits the PDSCH 1042 according to the DCI 1040. The receiving device 1004 may fail to decode the DCI 1040 in which case the receiving device also fails to receive the PDSCH 1042 but does not transmit a NACK 1044 because the receiving device was unaware of the PDSCH 1042. If the receiving device 1004 receives the DCI 1040 and receives the bits of the PDSCH 1042, but is unable to decode the transmission, the receiving device 1004 may transmit the NACK 1044.

If the transmitting device 1002 receives the NACK 1044 or does not receive any ACK/NACK, the transmitting device may schedule a retransmission via the DCI 1050. The DCI 1050 has the same HARQ process number and NDI as the DCI 1040, but the RVID field has a value of 1. If the receiving device 1004 receives the DCI 1050, the receiving device 1004 may determine the constant number of bits based on the scheduling information of the DCI 1050. Then, depending on whether the receiving device 1004 received the DCI 1040, the receiving device 1004 can determine the starting position for the bits of the PDSCH 1052. The receiving device 1004 may transmit a NACK 1054 if the receiving device received the DCI 1050 but is unable to decode the transmission.

If the transmitting device 1002 receives the NACK 1054 or does not receive any ACK/NACK, the transmitting device may schedule another retransmission via the DCI 1060. The DCI 1060 has the same HARQ process number and NDI as the DCI 1040, but the RVID field has a value of 2. If the receiving device 1004 receives the DCI 1060, the receiving device 1004 may determine the constant number of bits based on the scheduling information of the DCI 1060. In some implementations, where the receiving device 1004 received the DCI 1040 or the DCI 1050, the receiving device 1004 may assume or check that the constant number of bits is the same as previously indicated. Then the receiving device 1004 can determine the starting position for the bits of the PDSCH 1062 based on the constant number of bits and whether either of the previous DCIs was missed. The receiving device 1004 may transmit an ACK 1064 if the receiving device is able to decode the transmission. If the receiving device 1004 is unable to decode the transmission, the transmitting device 1002 may continue transmitting retransmissions until the receiving device decodes the transmission or a maximum number of retransmissions is reached.

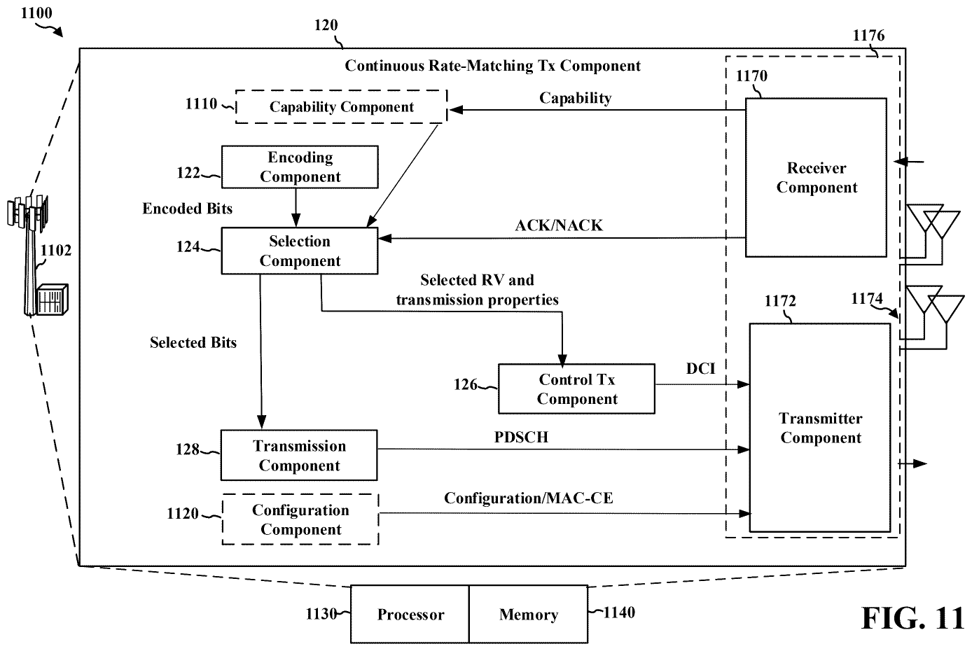

FIG. 11 is a conceptual data flow diagram 1100 illustrating the data flow between different means/components in an example network entity 1102 including a continuous rate-matching Tx component 120. For example, the network entity 1102 may be an example of a network node such as the base station 102 (FIG. 1) including the continuous rate-matching Tx component 120. In some implementations, the continuous rate-matching Tx component 120 may be implemented by the memory 376 and the TX processor 316, the RX processor 370, and/or the controller/processor 375 of FIG. 3. For example, the memory 376 may store executable instructions defining the continuous rate-matching Tx component 120 and the TX processor 316, the RX processor 370, and/or the controller/processor 375 may execute the instructions. In other implementations, the continuous rate-matching Tx component 120 may be implemented on computing resources including one or more processors 1130 and one or more memories 1140. For example, the continuous rate-matching Tx component 120 may be implemented on a virtual DU in a datacenter.

As discussed with respect to FIG. 1, the continuous rate-matching Tx component 120 may include the encoding component 122, the selection component 124, the control Tx component 126, and the transmission component 128. The continuous rate-matching Tx component 120 may optionally include a capability component 1110 and/or a configuration component 1120.

The network entity 1102 may include a receiver component 1170, which may include, for example, a radio frequency (RF) receiver for receiving the signals described herein. The network entity 1102 may include a transmitter component 1172, which may include, for example, an RF transmitter for transmitting the signals described herein. The transmitter component 1172 may output RF signals to one or more antennas 1174. In an aspect, the receiver component 1170 and the transmitter component 1172 may be co-located in a transceiver 1176, which may correspond to the TX/RX 318 in FIG. 3.

The capability component 1110 may be configured to receive an indication of a capability for continuous rate-matching from a UE via the receiver component 1170. The capability component 1110 may identify a UE that is capable of continuous rate-matching to the selection component 124 and/or the configuration component 1120.

The configuration component 1120 may be configured to transmit signaling indicating that continuous rate-matching is activated. For example, the configuration component 1120 may output the configuration 1020 and/or the MAC-CE 1030 via the transmitter component 1172 to indicate that continuous rate-matching is activated for a UE.

The encoding component 122 is configured to encode data for a HARQ process as a plurality of encoded bits. The encoding component 122 may receive the data from higher layers. The encoding component 122 may apply an encoder operating at a coding rate to generate the encoded bits. For example, the encoder may be a low density parity check (LDPC) encoder, a polar encoder, a turbo encoder, or other encoder. The encoder generates a number of bits that is greater than the original data bits. In some implementations, the encoded bits may include information bits or systemic bits and parity bits. A decoder only needs to receive a subset of the encoded bits in order to produce the original data bits. The encoding component 122 may output the encoded bits to the selection component 124.

The selection component 124 is configured to select a subset of the plurality of encoded bits for a transmission based on a constant number of bits for the HARQ process and a redundancy version of the transmission. The selection component 124 may receive ACK/NACK indications via the receiver component 1170. In some implementations, if the selection component 124 receives a NACK for the HARQ process, the selection component 124 may select the next redundancy version. In some implementations, the selection component 124 can determine the constant number of bits based on the quantity of the encoded bits and the number of redundancy versions. The selection component 124 may select transmission properties to transmit the constant number of bits taking into consideration channel conditions and overhead. The selection component 124 may output the selected RV and selected transmission properties to the control Tx component 126.

The selection component 124 may select the encoded bits corresponding to the selected RV. The selection component 124 may output the selected bits to the transmission component 128.

The control Tx component 126 is configured to transmit control information (e.g., DCI) including a RVID field that indicates the selected redundancy version. As discussed above, the selected redundancy version may be indicated as a counter or as an absolute value. The control Tx component 126 may generate the control information based on the transmission properties according to a format (e.g., DCI format 1_0). In some implementations, the control Tx component 126 may set a bit to indicate that continuous rate-matching is applicable. The control Tx component 126 may output the control information for transmission via the transmitter component 1172.

The transmission component 128 is configured to transmit the subset of the plurality of encoded bits according to the control information. For example, the transmission component 128 may map the selected bits to modulation symbols based on the control information. The transmission component 128 may designate the resources for transmission based on the control information. The transmission component 128 may output a transmission or retransmission as a PDSCH for transmission via the transmitter component 1172.

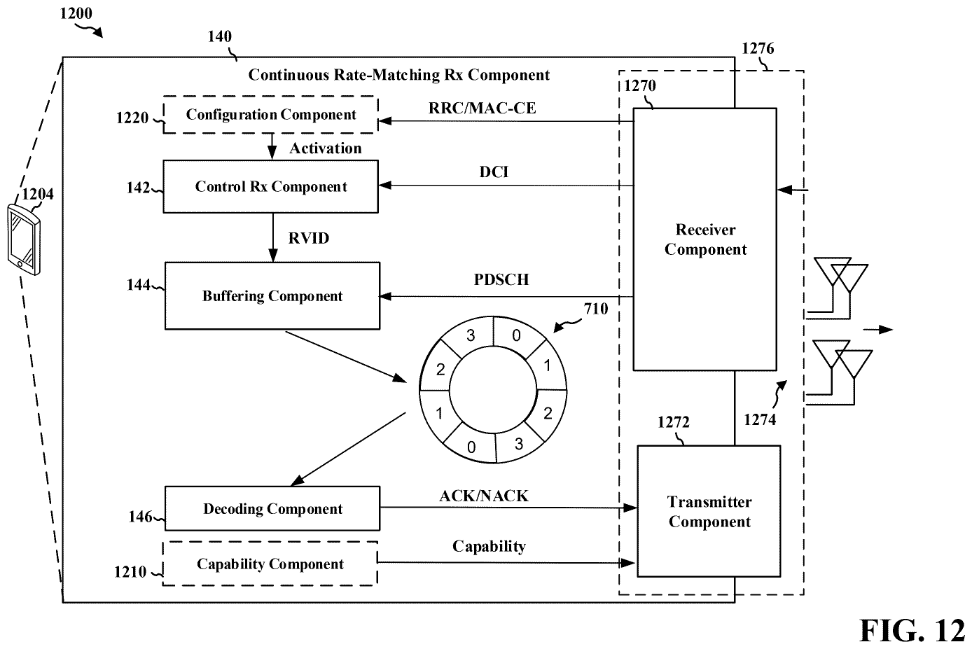

FIG. 12 is a conceptual data flow diagram 1200 illustrating the data flow between different means/components in an example UE 1204 including a continuous rate-matching Rx component 140. For example, the UE 1204 may be an example of a wireless node such as the UE 104 (FIG. 1) including the continuous rate-matching Rx component 140. The continuous rate-matching Rx component 140 may be implemented by the memory 360 and the TX processor 368, the RX processor 356, and/or the controller/processor 368 of FIG. 3. For example, the memory 360 may store executable instructions defining the continuous rate-matching Rx component 140 and the TX processor 368, the RX processor 356, and/or the controller/processor 359 may execute the instructions.

The UE 1204 may include a receiver component 1270, which may include, for example, a radio frequency (RF) receiver for receiving the signals described herein. The UE 1204 may include a transmitter component 1272, which may include, for example, an RF transmitter for transmitting the signals described herein. The transmitter component 1272 may output RF signals to one or more antennas 1274. In an aspect, the UE 1204 and the transmitter component 1272 may be co-located in a transceiver 1276, which may correspond to the TX/RX 354 in FIG. 3.

As discussed with respect to FIG. 1, the continuous rate-matching Rx component 140 may include the control Rx component 142, the buffering component 144, and the decoding component 146. The continuous rate-matching Rx component 140 may optionally include a capability component 1210 and/or a configuration component 1220.

The capability component 1210 may be configured to transmit an indication of a capability 1010 for continuous rate-matching. For example, the indication may be an RRC capability message transmit via the transmitter component 1272.

The receiver component 1270 may receive signals from a network entity such as a base station 102. For example, the receiver component 1270 may receive the configuration 1020, the MAC-CE 1030, the DCIs 1040, 1050, 1060, and/or the PDSCH 1042, 1052, 1062. The receiver component 1270 may output the configuration 1020 and/or the MAC-CE to the configuration component 1220. The receiver component 1270 may output the DCIs 1040, 1050, 1060 to the control Rx component 142. The receiver component 1270 may output the PDSCH 1042, 1052, 1062 to the buffering component 144.

The configuration component 1220 may be configured to receive signaling indicating that continuous rate-matching is activated. For example, the configuration component 1220 may receive the configuration 1020 and/or the MAC-CE via the receiver component 1270. The configuration component 1220 may output a signal that continuous rate-matching is activated.

The control Rx component 142 is configured to receive control information including a RVID field associated with a HARQ process. For example, the control Rx component 142 may receive the control information (e.g., a DCI) via the receiver component 1270. The control Rx component 142 may decode the control information to determine values of fields therein. In particular, the control Rx component 142 may determine the value of the RVID field. In some implementations, the control Rx component 142 may determine whether an additional bit of the RVID field or the control information indicates that continuous rate-matching is applicable. The control Rx component 142 may also determine transmission properties of PDSCH based on the control information. For example, the transmission properties may include a MCS and allocated resources. The control Rx component 142 may output the RVID and transmission properties to the buffering component 144.

The buffering component 144 is configured to load coded bits of a transmission scheduled by the control information starting at a starting position within a circular buffer based on the RVID and a constant number of bits for the HARQ process. The buffering component may receive the transmission (e.g., PDSCH) via the receiver component 1270 based on the transmission properties. In some implementations, when the transmission is the first transmission for the HARQ process received at the UE 1204, the buffering component 144 may determine the constant number of bits for the HARQ process, for example, based on the transmission properties. If the transmission is a retransmission, the buffering component 144 may expect the transmission properties to indicate the same number of bits as a previous transmission. The buffering component 144 may determine the starting position based in the RVID and any previously received transmissions. For instance, the buffering component 144 may determine a number of missed control information based on the RVID values and multiply by the constant number of bits to determine a number of bits to skip from a last bit in the circular buffer 710. The buffering component 144 may load the constant number of bits into the circular buffer 710 starting at the starting position.

The decoding component 146 is configured to decode the coded bits within the circular buffer. The decoding component 146 may include a decoder corresponding to the encoder of the encoding component 122. The decoding component 146 may apply the decoder to the bits in the circular buffer 710. In some implementations, the decoding component 146 may output an ACK or NACK based on whether the decoding component 146 was able to decode the transmission.

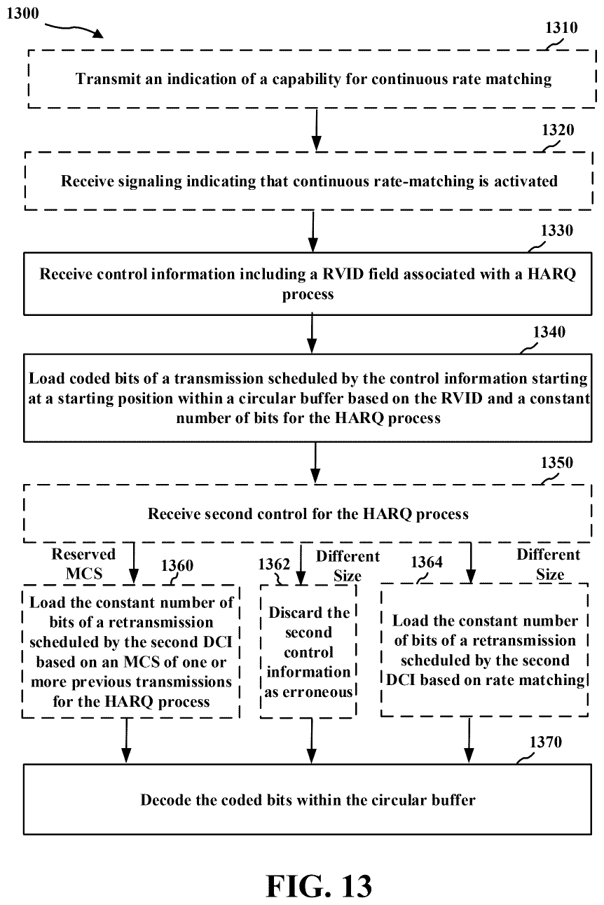

FIG. 13 is a flowchart of an example method 1300 for a wireless node such as a UE to receive a message based on continuous rate-matching. The method 1300 may be performed by a UE (such as the UE 104, which may include the memory 360 and which may be the entire UE 104 or a component of the UE 104 such as the continuous rate-matching Rx component 140, TX processor 368, the RX processor 356, or the controller/processor 359). The method 1300 may be performed by the continuous rate-matching Rx component 140 in communication with continuous rate-matching Tx component 120 at a network entity. Optional blocks are shown with dashed lines.

At block 1310, the method 1300 may optionally include transmitting an indication of a capability for continuous rate matching. In some implementations, for example, the UE 104, the TX processor 368 or the controller/processor 359 may execute the continuous rate-matching Rx component 140 or the capability component 1210 to transmit an indication of a capability 1010 for continuous rate matching. Accordingly, the UE 104, the Tx processor 368, or the controller/processor 359 executing the continuous rate-matching Rx component 140 or the capability component 1210 may provide means for transmitting an indication of a capability for continuous rate matching.

At block 1320, the method 1300 may optionally include receiving signaling indicating that continuous rate-matching is activated. In some implementations, for example, the UE 104, the RX processor 356 or the controller/processor 359 may execute the continuous rate-matching Rx component 140 or the configuration component 1220 to receive signaling (e.g., continuous RM configuration 1020 and/or MAC-CE 1030) indicating that continuous rate-matching is activated. Accordingly, the UE 104, the RX processor 356, or the controller/processor 359 executing the continuous rate-matching Rx component 140 or the configuration component 1220 may provide means for receiving signaling indicating that continuous rate-matching is activated.

At block 1330, the method 1300 includes receiving control information including a RVID field associated with a HARQ process. In some implementations, for example, the UE 104, the RX processor 356 or the controller/processor 359 may execute the continuous rate-matching Rx component 140 or the control Rx component 142 to receive control information (e.g., DCI 1040, 1050, or 1060) including a RVID field associated with a HARQ process. Accordingly, the UE 104, the RX processor 356, or the controller/processor 359 executing the continuous rate-matching Rx component 140 or the control Rx component 142 may provide means for receiving control information including a RVID field associated with a HARQ process.

At block 1340, the method 1300 includes loading coded bits of a transmission scheduled by the control information starting at a starting position within a circular buffer based on the RVID and a constant number of bits for the HARQ process. In some implementations, for example, the UE 104, the RX processor 356 or the controller/processor 359 may execute the continuous rate-matching Rx component 140 or the buffering component 144 to load coded bits of a transmission scheduled by the control information starting at a starting position within a circular buffer based on the RVID and a constant number of bits for the HARQ process. Accordingly, the UE 104, the RX processor 356, or the controller/processor 359 executing the continuous rate-matching Rx component 140 or the buffering component 144 may provide means for loading coded bits of a transmission scheduled by the control information starting at a starting position within a circular buffer based on the RVID and a constant number of bits for the HARQ process.

At block 1350, the method 1300 may optionally include receiving second control information for the HARQ process. In some implementations, for example, the UE 104, the RX processor 356 or the controller/processor 359 may execute the continuous rate-matching Rx component 140 or the control Rx component 142 to receive second control information (e.g., DCI 1040, 1050, or 1060). Accordingly, the UE 104, the RX processor 356, or the controller/processor 359 executing the continuous rate-matching Rx component 140 or the control Rx component 142 may provide means for receiving second control information for the HARQ process. In some implementations, if the second control information indicates a same constant number of bits, the buffering component 144 may load the coded bits in the same manner as block 1340.

In some implementations, the second control information may include an MCS field that indicates a reserved value for the MCS. The continuous rate-matching Rx component 140 and/or the control Rx component 142 may interpret the reserved value for the MCS to indicate a value of a previous transmission. At block 1360, the method 1300 may optionally include loading the constant number of bits of a retransmission scheduled by the second DCI based on an MCS of one or more previous transmissions for the HARQ process.

In some implementations, the second control information may indicate a different size than the constant number of bits. In some implementations, at block 1362, the control Rx component 142 may discard the second control information as erroneous. In other implementations, at block 1364, the control Rx component 142 may pass the transmission parameters to the buffering component 144. The buffering component 144 may load the constant number of bits of a retransmission scheduled by the second DCI based on rate matching.

At block 1370, the method 1300 includes decoding the coded bits within the circular buffer. In some implementations, for example, the UE 104, the RX processor 356 or the controller/processor 359 may execute the continuous rate-matching Rx component 140 or the decoding component 146 to decode the coded bits within the circular buffer 710. Accordingly, the UE 104, the RX processor 356, or the controller/processor 359 executing the continuous rate-matching Rx component 140 or the decoding component 146 may provide means for decoding the coded bits within the circular buffer.

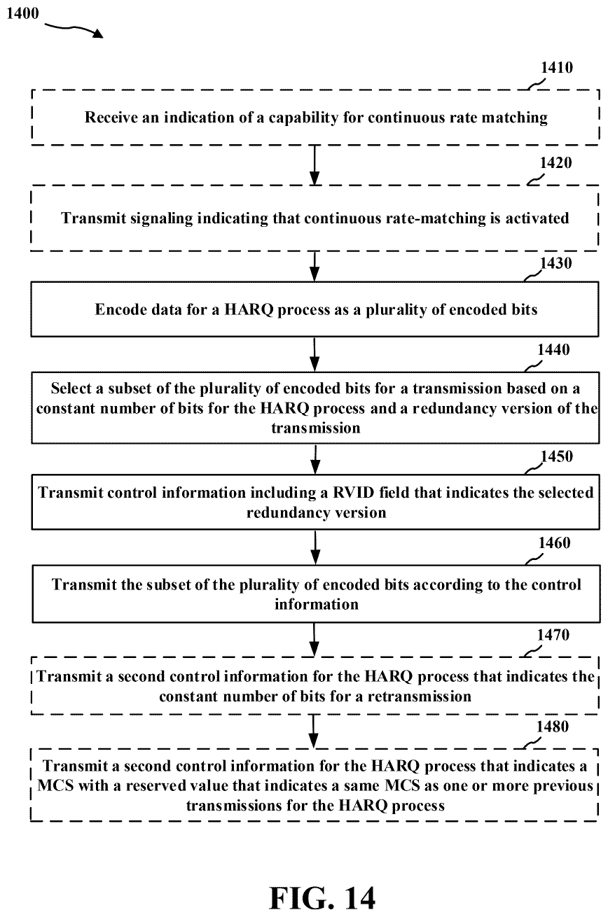

FIG. 14 is a flowchart of an example method 1400 for a wireless node such as a network entity to transmit a transmission associated with a HARQ process using continuous rate-matching. The method 1400 may be performed by a network entity 1102 such as a base station (such as the base station 102, which may include the memory 376 and which may be the entire base station 102 or a component of the base station 102 such as a DU 430 including the continuous rate-matching Tx component 120, TX processor 316, RX processor 370, or the controller/processor 375). The method 1400 may be performed by the continuous rate-matching Tx component 120 in communication with the continuous rate-matching Rx component 140 at a UE. Optional blocks are shown with dashed lines.

At block 1410, the method 1400 may optionally include receiving an indication of a capability for continuous rate matching. In some implementations, for example, the network entity 1102, the RX processor 370, or the controller/processor 375 may execute the continuous rate-matching Tx component 120 or the capability component 1110 to receive an indication of a capability for continuous rate matching. Accordingly, the network entity 1102, the RX processor 370, or the controller/processor 375 executing continuous rate-matching Tx component 120 or the capability component 1110 may provide means receiving an indication of a capability for continuous rate matching.

At block 1420, the method 1400 may optionally include transmitting signaling indicating that continuous rate-matching is activated. In some implementations, for example, the network entity 1102, the TX processor 316, or the controller/processor 375 may execute the continuous rate-matching Tx component 120 or the configuration component 1120 to transmit signaling indicating that continuous rate-matching is activated. Accordingly, the network entity 1102, the Tx processor 316, or the controller/processor 375 executing the continuous rate-matching Tx component 120 or the configuration component 1120 may provide means for transmitting signaling indicating that continuous rate-matching is activated.

At block 1430, the method 1400 includes encoding data for a HARQ process as a plurality of encoded bits. In some implementations, for example, the network entity 1102, the TX processor 316, or the controller/processor 375 may execute the continuous rate-matching Tx component 120 or the encoding component 122 to encode data for a HARQ process as a plurality of encoded bits. Accordingly, the network entity 1102, the Tx processor 316, or the controller/processor 375 executing the continuous rate-matching Tx component 120 or encoding component 122 may provide means for encoding data for a HARQ process as a plurality of encoded bits.

At block 1440, the method 1400 includes selecting a subset of the plurality of encoded bits for a transmission based on a constant number of bits for the HARQ process and a redundancy version of the transmission. In some implementations, for example, the network entity 1102, the TX processor 316, or the controller/processor 375 may execute the continuous rate-matching Tx component 120 or the selection component 124 to select a subset of the plurality of encoded bits for a transmission based on a constant number of bits for the HARQ process and a redundancy version of the transmission. Accordingly, the network entity 1102, the TX processor 316, or the controller/processor 375 executing the continuous rate-matching Tx component 120 or the selection component 124 may provide means for selecting a subset of the plurality of encoded bits for a transmission based on a constant number of bits for the HARQ process and a redundancy version of the transmission.

At block 1450, the method 1400 includes transmitting control information including a RVID field that indicates the selected redundancy version. In some implementations, for example, the network entity 1102, the TX processor 316, or the controller/processor 375 may execute the continuous rate-matching Tx component 120 or the control Tx component 126 to transmit control information including a RVID field that indicates the selected redundancy version. Accordingly, the network entity 1102, the TX processor 316, or the controller/processor 375 executing the continuous rate-matching Tx component 120 or the control Tx component 126 may provide means for transmitting control information including a RVID field that indicates the selected redundancy version.

At block 1460, the method 1400 includes transmitting the subset of the plurality of encoded bits according to the control information. In some implementations, for example, the network entity 1102, the TX processor 316, or the controller/processor 375 may execute the continuous rate-matching Tx component 120 or the transmission component 128 to transmit the subset of the plurality of encoded bits according to the control information. Accordingly, the network entity 1102, the TX processor 316, or the controller/processor 375 executing the continuous rate-matching Tx component 120 or the transmission component 128 may provide means for transmitting the subset of the plurality of encoded bits according to the control information.

At block 1470, the method 1400 may optionally include transmitting a second control information for the HARQ process that indicates the constant number of bits for a retransmission. In some implementations, for example, the network entity 1102, the TX processor 316, or the controller/processor 375 may execute the continuous rate-matching Tx component 120 or the control Tx component 126 to transmit a second control information for the HARQ process that indicates the constant number of bits for a retransmission. Accordingly, the network entity 1102, the TX processor 316, or the controller/processor 375 executing the continuous rate-matching Tx component 120 or the selection component 124 may provide means for transmitting a second control information for the HARQ process that indicates the constant number of bits for a retransmission.

At block 1480, the method 1400 may optionally include transmitting a second control information for the HARQ process that indicates a MCS with a reserved value that indicates a same MCS as one or more previous transmissions for the HARQ process. In some implementations, for example, the network entity 1102, the TX processor 316, or the controller/processor 375 may execute the continuous rate-matching Tx component 120 or the control Tx component 126 to transmit a second control information for the HARQ process that indicates a MCS with a reserved value that indicates a same MCS as one or more previous transmissions for the HARQ process. Accordingly, the network entity 1102, the TX processor 316, or the controller/processor 375 executing the continuous rate-matching Tx component 120 or the selection component 124 may provide means for transmitting a second control information for the HARQ process that indicates a MCS with a reserved value that indicates a same MCS as one or more previous transmissions for the HARQ process.

In some cases, rather than actually transmitting a message, a device may have an interface to output a message for transmission (a means for outputting). For example, a processor may output a message, via a bus interface, to a radio frequency (RF) front end for transmission. Similarly, rather than actually receiving a message, a device may have an interface to obtain a message received from another device (a means for obtaining). For example, a processor may obtain (or receive) a message, via a bus interface, from an RF front end for reception. In some cases, the interface to output a message for transmission and the interface to obtain a message (which may be referred to as first and second interfaces herein) may be the same interface.

The following numbered clauses provide an overview of aspects of the present disclosure:

Clause 1. A method of wireless communication, comprising: receiving control information including a redundancy version identifier (RVID) field associated with a hybrid automatic repeat request (HARQ) process; loading coded bits of a transmission scheduled by the control information starting at a starting position within a circular buffer based on the RVID and a constant number of bits for the HARQ process; and decoding the coded bits within the circular buffer.

Clause 2. The method of clause 1, wherein the starting position is further based on a previous transmission corresponding to the transmission and associated with a previous RVID for the HARQ process, wherein the RVID field is a counter that indicates a multiple of the constant number of bits for the transmission.

Clause 3. The method of clause 2, wherein the starting position is an ending position of the previous transmission plus a difference between a value of the RVID field and the previous RVID reduced modulo a number of possible RVIDs minus one times the constant number of bits for the transmission.

Clause 3a. The method of clause 2, wherein the starting position is a starting position of the previous transmission plus a difference between a value of the RVID field and the previous RVID reduced modulo a number of possible RVIDs times the constant number of bits for the transmission.

Clause 4. The method of clause 2, wherein control information for the previous transmission was not received and a value of 0 is assumed for the RVID of the previous transmission.

Clause 5. The method of clause 1, wherein the RVID field indicates an absolute starting position within the circular buffer.

Clause 6. The method of clause 5, wherein the absolute starting position is a value of the RVID field times the constant number of bits.

Clause 7. The method of any of clauses 1-6, wherein the constant number of bits for the transmission is based on a modulation and coding scheme, a number of layers, and a resource allocation indicated by the control information.

Clause 8. The method of clause 7, further comprising: receiving a second control information for the HARQ process that indicates a different number of bits than the constant number of bits; and discarding the second control information as erroneous.

Clause 9. The method of any of clauses 1-6, wherein the constant number of bits for the transmission is based on rate matching for the scheduled transmission including reserved resources within the scheduled transmission.

Clause 10. The method of any of clauses 1-9, further comprising: receiving a second control information for the HARQ process that indicates a different number of bits than the constant number of bits; and loading the constant number of bits of a retransmission scheduled by the second control information based on rate matching.

Clause 11. The method of any of clauses 1-10, further comprising receiving signaling indicating that continuous rate-matching is activated, wherein the constant number of bits for the HARQ process is inferred based on the activation of continuous rate matching.

Clause 12. The method of any of clauses 1-11, further comprising: receiving a second control information for the HARQ process that indicates a modulation and coding scheme (MCS) with a reserved value; and loading the constant number of bits of a retransmission scheduled by the second control information based on an MCS of one or more previous transmissions for the HARQ process.

Clause 13. The method of any of clauses 1-12, wherein the control information includes a bit that indicates whether continuous rate-matching applies to the HARQ process.

Clause 14. The method of clause 13, wherein the bit is an additional bit to the RVID field.

Clause 15. The method of clause 13, wherein the bit is a bit of the RVID field.

Clause 16. The method of any of clauses 1-15, further comprising transmitting an indication of a capability for continuous rate matching.

Clause 17. A method of wireless communication, comprising: encoding data for a hybrid automatic repeat request (HARQ) process as a plurality of encoded bits; selecting a subset of the plurality of encoded bits for a transmission based on a constant number of bits for the HARQ process and a redundancy version of the transmission; transmitting control information including a redundancy version identifier (RVID) field that indicates the selected redundancy version; and transmitting the subset of the plurality of encoded bits according to the control information.

Clause 18. The method of clause 17, wherein the RVID field is a counter that indicates a multiple of the constant number of bits for the transmission.

Clause 19. The method of clause 17, wherein the RVID field indicates an absolute starting position within the circular buffer.

Clause 20. The method of clause 19, wherein the absolute starting position is a value of the RVID field times the constant number of bits.

Clause 21. The method of any of clauses 17-20, wherein the control information indicates a modulation and coding scheme, a number of layers, and a resource allocation based on the constant number of bits for the transmission.

Clause 22. The method of clause 21, further comprising transmitting a second control information for the HARQ process that indicates the constant number of bits for a retransmission.

Clause 23. The method of any of clauses 17-20, wherein the constant number of bits for the transmission is based on rate matching for the scheduled transmission including reserved resources within the scheduled transmission.

Clause 24. The method of any of clauses 17-23, further comprising transmitting signaling indicating that continuous rate-matching is activated, wherein the constant number of bits for the HARQ process is inferred based on the activation of continuous rate matching.

Clause 25. The method of any of clauses 17-24, further comprising transmitting a second control information for the HARQ process that indicates a modulation and coding scheme (MCS) with a reserved value that indicates a same MCS as one or more previous transmissions for the HARQ process.

Clause 26. The method of any of clauses 17-25, wherein the control information includes a bit that indicates whether continuous rate-matching applies to the HARQ process.

Clause 27. The method of any of clauses 17-26, further comprising receiving an indication of a capability for continuous rate matching.

Clause 28 is an apparatus for wireless communications, comprising means for performing a method in accordance with any one of clauses 1-16.

Clause 29 is an apparatus for wireless communications, comprising means for performing a method in accordance with any one of clauses 17-27.

Clause 30 is a non-transitory computer-readable medium comprising instructions that, when executed by a wireless node (e.g., UE), cause the wireless node to perform a method in accordance with any one of clauses 1-16.

Clause 31 is a non-transitory computer-readable medium comprising instructions that, when executed by a wireless node (e.g., network entity), cause the wireless node to perform a method in accordance with any one of clauses 17-27.

Clause 32 is an apparatus for wireless communications, comprising: one or more memories, individually or in combination, having instructions; and one or more processors, individually or in combination, configured to execute the instructions and cause the apparatus to perform a method in accordance with any one of clauses 1-16.

Clause 33 is an apparatus for wireless communications, comprising: one or more memories, individually or in combination, having instructions; and one or more processors, individually or in combination, configured to execute the instructions and cause the apparatus to perform a method in accordance with any one of clauses 17-27.

Clause 34 is a wireless node (e.g., UE), comprising: one or more transceivers; one or more memories, individually or in combination, having instructions; and one or more processors, individually or in combination, configured to execute the instructions and cause the wireless node to perform a method in accordance with any one of clauses 1-16, wherein the one or more transceivers are configured to: receive the control information.

Clause 35 is a wireless node (e.g., network entity such as a DU), comprising: one or more transceivers; one or more memories, individually or in combination, having instructions; and one or more processors, individually or in combination, configured to execute the instructions and cause the wireless node to perform a method in accordance with any one of clauses 17-27, wherein the one or more transceivers are configured to: transmit the control information and the subset of the plurality of encoded bits.

As used herein, a phrase referring to “at least one of” a list of items refers to any combination of those items, including single members. As an example, “at least one of: a, b, or c” is intended to cover: a, b, c, a-b, a-c, b-c, and a-b-c. Similarly, as used herein, a phrase referring to “one or more of” a list of items refers to any combination of those items, including single members. As an example, “one or more of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for wireless communication, comprising:
one or more memories, individually or in combination, having instructions; and
one or more processors, individually or in combination, configured to execute the instructions and cause the apparatus to:
receive control information including a redundancy version identifier (RVID) field associated with a hybrid automatic repeat request (HARQ) process;
load coded bits of a transmission scheduled by the control information starting at a starting position within a circular buffer based on the RVID and a constant number of bits for the HARQ process; and
decode the coded bits within the circular buffer.

2. The apparatus of claim 1, wherein the starting position is further based on a previous transmission corresponding to the transmission and associated with a previous RVID for the HARQ process, wherein the RVID field is a counter that indicates a multiple of the constant number of bits for the transmission.

3. The apparatus of claim 2, wherein the starting position is an ending position of the previous transmission plus a difference between a value of the RVID field and the previous RVID, reduced modulo a number of possible RVIDs minus one times the constant number of bits for the transmission.

4. The apparatus of claim 2, wherein control information for the previous transmission was not received and a value of 0 is assumed for the RVID of the previous transmission.

5. The apparatus of claim 1, wherein the RVID field indicates an absolute starting position within the circular buffer.

6. The apparatus of claim 5, wherein the absolute starting position is a value of the RVID field times the constant number of bits.

7. The apparatus of claim 1, wherein the constant number of bits for the transmission is based on a modulation and coding scheme, a number of layers, and a resource allocation indicated by the control information.

8. The apparatus of claim 7, wherein the one or more processors, individually or in combination, are further configured to:
receive a second control information for the HARQ process that indicates a different number of bits than the constant number of bits; and
discard the second control information as erroneous.

9. The apparatus of claim 1, wherein the constant number of bits for the transmission is based on rate matching for the scheduled transmission including reserved resources within the scheduled transmission.

10. The apparatus of claim 1, wherein the one or more processors, individually or in combination, are further configured to:
receive a second control information for the HARQ process that indicates a different number of bits than the constant number of bits; and
load the constant number of bits of a retransmission scheduled by the second control information based on rate matching.

11. The apparatus of claim 1, wherein the one or more processors, individually or in combination, are further configured to receive signaling indicating that continuous rate-matching is activated, wherein the constant number of bits for the HARQ process is inferred based on the activation of continuous rate matching.

12. The apparatus of claim 1, wherein the one or more processors, individually or in combination, are further configured to:
receive a second control information for the HARQ process that indicates a modulation and coding scheme (MCS) with a reserved value; and
load the constant number of bits of a retransmission scheduled by the second control information based on an MCS of one or more previous transmissions for the HARQ process.

13. The apparatus of claim 1, wherein the control information includes a bit that indicates whether continuous rate-matching applies to the HARQ process.

14. The apparatus of claim 13, wherein the bit is an additional bit to the RVID field.

15. The apparatus of claim 13, wherein the bit is a bit of the RVID field.

16. The apparatus of claim 1, wherein the one or more processors, individually or in combination, are further configured to transmit an indication of a capability for continuous rate matching.

17. An apparatus for wireless communication, comprising:
one or more memories, individually or in combination, having instructions; and
one or more processors, individually or in combination, configured to execute the instructions and cause the apparatus to:
encode data for a hybrid automatic repeat request (HARQ) process as a plurality of encoded bits;
select a subset of the plurality of encoded bits for a transmission based on a constant number of bits for the HARQ process and a redundancy version of the transmission;
transmit control information including a redundancy version identifier (RVID) field that indicates the selected redundancy version; and
transmit the subset of the plurality of encoded bits according to the control information.

18. The apparatus of claim 17, wherein the RVID field is a counter that indicates a multiple of the constant number of bits for the transmission.

19. The apparatus of claim 17, wherein the RVID field indicates an absolute starting position within a circular buffer.

20. The apparatus of claim 19, wherein the absolute starting position is a value of the RVID field times the constant number of bits.

21. The apparatus of claim 17, wherein the control information indicates a modulation and coding scheme, a number of layers, and a resource allocation based on the constant number of bits for the transmission.

22. The apparatus of claim 21 wherein the one or more processors, individually or in combination, are further configured to transmit a second control information for the HARQ process that indicates the constant number of bits for a retransmission.

23. The apparatus of claim 17, wherein the constant number of bits for the transmission is based on rate matching for a transmission of the subset of the plurality of bits including reserved resources within the transmission.

24. The apparatus of claim 17, wherein the one or more processors, individually or in combination, are further configured to transmit signaling indicating that continuous rate-matching is activated, wherein the constant number of bits for the HARQ process is inferred based on the activation of continuous rate matching.

25. The apparatus of claim 17, wherein the one or more processors, individually or in combination, are further configured to transmit a second control information for the HARQ process that indicates a modulation and coding scheme (MCS) with a reserved value that indicates a same MCS as one or more previous transmissions for the HARQ process.

26. The apparatus of claim 17, wherein the control information includes a bit that indicates whether continuous rate-matching applies to the HARQ process.

27. The apparatus of claim 17, wherein the one or more processors, individually or in combination, are further configured to receive an indication of a capability for continuous rate matching.

28. A method of wireless communication, comprising:
receiving control information including a redundancy version identifier (RVID) field associated with a hybrid automatic repeat request (HARQ) process;
loading coded bits of a transmission scheduled by the control information starting at a starting position within a circular buffer based on the RVID and a constant number of bits for the HARQ process; and
decoding the coded bits within the circular buffer.

29. A method of wireless communication, comprising:
encoding data for a hybrid automatic repeat request (HARQ) process as a plurality of encoded bits;
selecting a subset of the plurality of encoded bits for a transmission based on a constant number of bits for the HARQ process and a redundancy version of the transmission;
transmitting control information including a redundancy version identifier (RVID) field that indicates the selected redundancy version; and
transmitting the subset of the plurality of encoded bits according to the control information.
